(19) United States
(12) Patent Application Publication
(10) Pub. No.: US 2024/0363949 A1
(43) Pub. Date: Oct. 31, 2024

(54) STACKABLE BATTERY MODULE MOUNTING SYSTEM

(71) Applicant: GM GLOBAL TECHNOLOGY OPERATIONS LLC, Detroit, MI (US)

(72) Inventors: Andrew Clay BOBEL, Troy, MI (US); Amanda HYDE, Warren, MI (US); Rajan R. CHAKRAVARTY, Troy, MI (US); Varun AGARWAL, Bengaluru (IN)

(21) Appl. No.: 18/307,468

(22) Filed: Apr. 26, 2023

(51) Int. Cl. H01M 50/264

(52) U.S. Cl. CPC H01M 50/264

(57) ABSTRACT

A stackable battery module mounting system includes a side wall structure and a plurality of cross members extending between opposite sides of the side wall structure, the plurality of cross members each having a plurality of first spaced apertures. A plurality of battery modules each include a face plate on opposite sides thereof and each face plate includes a plurality of protruding sections which nest with protruding sections of the face plate of adjacent battery modules. At least some of the protruding sections include second apertures aligned with a respective one of the first spaced apertures of the plurality of cross members. A plurality of bolts are received in corresponding ones of the second apertures of the plurality of battery modules and the first spaced apertures in the plurality of cross members for securing the plurality of battery modules to the plurality of cross members.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a stackable battery module mounting system.

In a hybrid or electric vehicle, at least a portion of the motive power is provided by one or more rechargeable battery packs that act as a direct current (DC) voltage source to a motor, generator, or transmission, which in turn may be used to provide the energy needed to rotate the vehicle's wheels. The rechargeable battery packs each include a series of individual battery cells. A rechargeable energy storage systems (RESS) refers to a system including the rechargeable battery packs as well as the various ancillary subsystems for thermal management, electronic control, support, and enclosure. One such component of the RESS is a battery tray, which is used to secure the battery cells.

Current battery trays may be constructed of plain-carbon ferritic steels with strengths of about 300 Megapascals. The battery tray constructed from this plain-carbon steel may require numerous reinforcements and stiffening features to provide the required structural performance. However, the reinforcements require dedicated packaging space that could otherwise be used to house batteries. Also, the reinforcements and stiffening features may complicate the assembly process and also incur additional weight and costs. Furthermore, the battery tray may also undergo an electrocoat paint operation (ELPO) in order to introduce a protective coating.

Thus, while current battery trays achieve their intended purpose, there is a need in the art for a battery module mounting system having a relatively simple, lightweight design that has fewer packaging constraints.

### SUMMARY

According to an aspect of the present disclosure, a stackable battery module mounting system includes a side wall structure and a plurality of cross members extending between opposite sides of the side wall structure, the plurality of cross members each having a plurality of first spaced apertures. A plurality of battery modules each include a face plate on opposite sides thereof and each face plate includes a plurality of protruding sections which nest with protruding sections of the face plate of adjacent battery modules. At least some of the protruding sections include a second apertures aligned with a respective one of the first spaced apertures of the plurality of cross members. A plurality of bolts are received in corresponding ones of the second apertures of the plurality of battery modules and the first spaced apertures in the plurality of cross members for securing the plurality of battery modules to the plurality of cross members.

According to a further aspect of the present disclosure, the plurality of battery modules include battery modules that are stacked upon another battery module.

According to a further aspect of the present disclosure, the plurality of cross members are connected to the side wall structure by a bracket secured to the side wall structure.

According to a further aspect of the present disclosure, a base panel is connected to the sidewall structure.

According to a further aspect of the present disclosure, the plurality of cross members include a plurality of lower cross members that are connected to the base panel and a plurality of upper cross members that are connected to the sidewall structure by mounting brackets.

According to a further aspect of the present disclosure, the plurality of battery modules include a first plurality of battery modules connected to the plurality of lower cross members and a second plurality of battery modules stacked on top of the plurality of first battery modules and connected to the plurality of upper cross members.

According to a further aspect of the present disclosure, the plurality of protruding sections of the face plates of the battery modules are spaced upward from a bottom of the plurality of battery modules by a distance approximately equal to a vertical height of the cross members.

According to a further aspect of the present disclosure, the plurality of protruding sections of the face plates of the battery modules include between 2 and 10 protruding sections.

According to a further aspect of the present disclosure, the face plate of the plurality of battery modules includes a plurality of recesses between the plurality of protruding sections.

According to another aspect of the present disclosure, a stackable battery module mounting system includes a base panel and a side wall structure connected to the base panel. A plurality of lower cross members are connected to the base panel and extend between opposing sides of the side wall structure, the plurality of lower cross members each having a plurality of first spaced apertures. A plurality of upper cross members are connected to the side wall structure above respective ones of the plurality of lower cross members, the plurality of upper cross members each having a plurality of second spaced apertures. A plurality of first battery modules each have a face plate on opposite sides thereof and each face plate includes a plurality of protruding sections which nest with protruding sections of a face plate of adjacent battery modules, at least some of the protruding sections include a third aperture aligned with a respective one of the first spaced apertures of the plurality of lower cross members. A plurality of second battery modules are stacked on top of respective ones of the plurality of first battery modules and each of the plurality of second battery modules have a face plate on opposite sides thereof and each face plate having a plurality of protruding sections which nest with protruding sections of a face plate of adjacent battery modules, at least some of the protruding sections including a fourth aperture aligned with a respective one of the second spaced apertures of the plurality of upper cross members. A plurality of bolts are each received in corresponding ones of the first and second apertures in the lower and upper cross members and the third and fourth apertures for securing the plurality of first and second battery modules to the plurality of lower and upper cross members.

According to a further aspect of the present disclosure, the plurality of upper cross members are connected to the side wall structure by a bracket secured to the side wall structure.

According to a further aspect of the present disclosure, the plurality of protruding sections of the face plates of the battery modules are spaced upward from a bottom of the plurality of battery modules by a distance approximately equal to a vertical height of the cross members.

According to a further aspect of the present disclosure, the plurality of protruding sections of the face plates of the battery modules include between 2 and 10 protruding sections.

According to a further aspect of the present disclosure, the face plate of the plurality of battery modules includes a plurality of recesses between the plurality of protruding sections.

According to another aspect of the present disclosure, a stackable battery module mounting system includes a side wall structure and a plurality of cross members extending between opposite sides of the side wall structure, the plurality of cross members each having a plurality of first spaced apertures. A plurality of battery modules each have a face plate on opposite sides thereof and each face plate includes a plurality of protruding sections which nest with protruding sections of face plates of adjacent battery modules, at least some of the protruding sections including a second aperture aligned with a respective one of the first spaced apertures of the plurality of cross members. A plurality of bolts are received in corresponding ones of the second apertures and the first spaced apertures for securing the plurality of battery modules to the plurality of cross members.

According to a further aspect of the present disclosure, the plurality of battery modules include battery modules that are stacked upon another battery module.

According to a further aspect of the present disclosure, the plurality of cross members are connected to the side wall structure by a bracket secured to the side wall structure.

According to a further aspect of the present disclosure, a base panel is connected to the sidewall structure.

According to a further aspect of the present disclosure, the plurality of cross members include a plurality of lower cross members that are connected to the base panel and a plurality of upper cross members that are connected to the sidewall structure by mounting brackets.

According to a further aspect of the present disclosure, the plurality of battery modules include a first plurality of battery modules connected to the plurality of lower cross members and a second plurality of battery modules stacked on top of the plurality of first battery modules and connected to the plurality of upper cross members.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of the sidewall structure and battery module mount plates engaging with the upper and lower cross members with the battery modules removed for illustration purposes;

FIG. 2 is a perspective view of a portion of the stackable battery module mount system housing;

FIG. 3 is a partial cross-sectional view of the stackable battery module mounting system according to the principles of the present disclosure;

FIG. 4 is a perspective view of the stackable battery module mounting system according to the principles of the present disclosure;

FIG. 5 is a top plan view of the stackable battery module mounting system with a cover removed for illustration purposes;

FIG. 6 is a top plan view of a battery module according to the principles of the present disclosure; and

FIG. 7 is a side plan view of the battery module shown in FIG. 6.

In the drawings, reference numbers may be reused to identify similar and/or identical elements.

### DETAILED DESCRIPTION

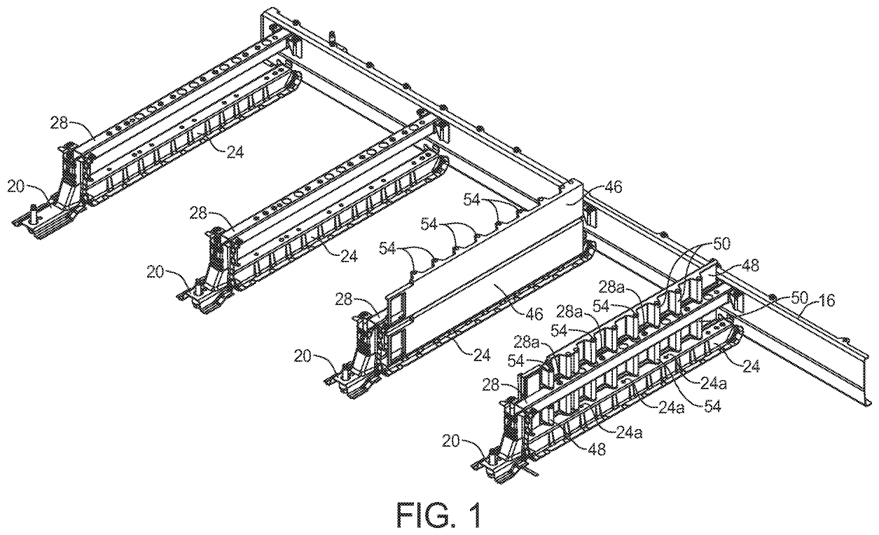

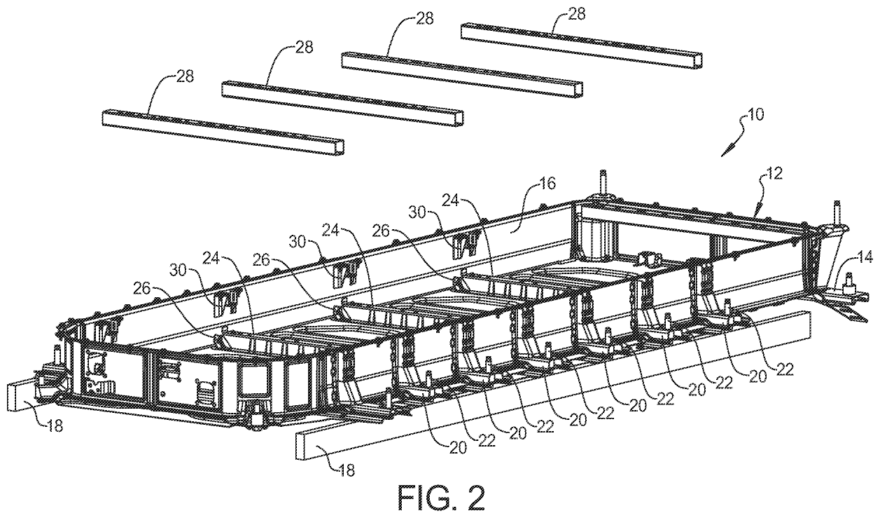

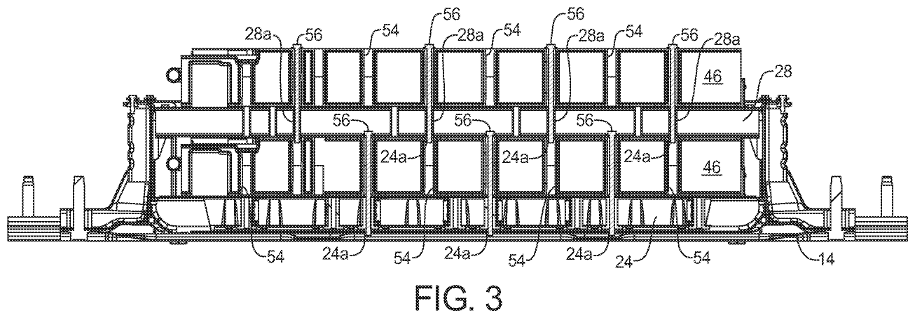

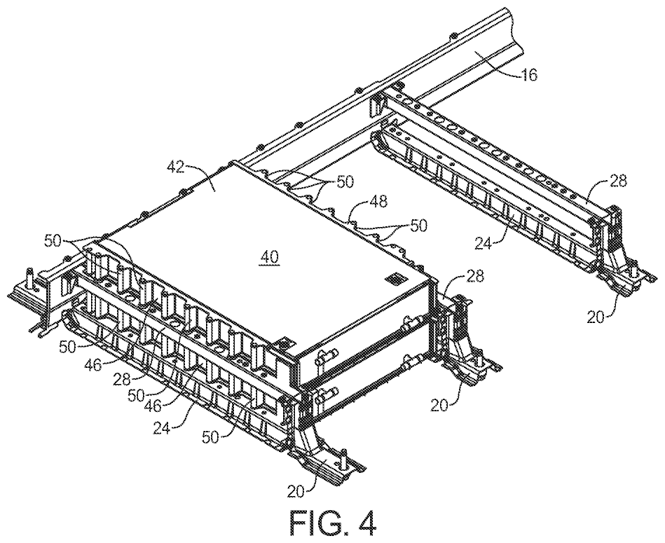

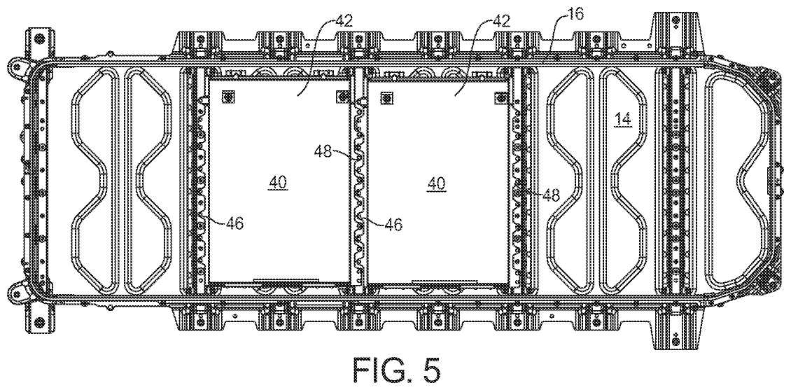

With reference to FIGS. 1-5, a stackable battery module mounting system 10 will be described. As shown in FIG. 2, the stackable battery mounting system 10 includes a housing 12 having a base panel 14 and a sidewall structure 16 mounted to the base panel 14. The housing 12 includes a cover (not shown) that is sealingly mounted to the sidewall structure 16. The sidewall structure 16 is mounted to the base panel 14 with a seal therebetween. The stackable battery module mounting system 10 is mounted to a vehicle chassis frame 18 by a plurality of brackets 20 that are connected to the chassis frame 18 by bolts 22. A plurality of lower cross members 24 extend between opposing sidewalls of the sidewall structure 16 and can be connected to the base panel 14 by welding and/or to the sidewall structure 16 by brackets 26. The lower cross members 24 each include a plurality of threaded apertures 24a or apertures that include a threaded nut therein, as best shown in FIGS. 1 and 3. A plurality of upper cross members 28 extend between opposing sidewalls of the sidewall structure 16 and above the lower cross members 24 by brackets 30. The upper cross members 28 each include a plurality of threaded apertures 28a or apertures that include a threaded nut therein, best shown in FIG. 3.

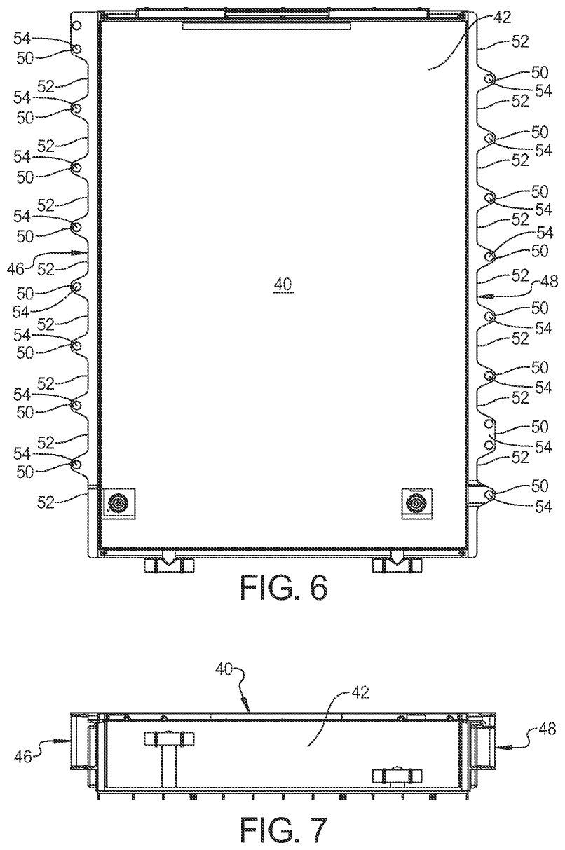

With reference to FIGS. 3-7, a plurality of battery modules 40 each include a housing 42 containing a plurality of battery cells and a front module mount plate 46 and a rear module mount plate 48. An exterior face of each of the front and rear module mount plates 46, 48 can be formed as a casting face to include a plurality of nesting protruding portions 50 and alternating recesses 52 so that the protruding portions 50 of a rear module mount plate 48 of the plurality of battery modules 40 nest within the recesses 52 of an adjacent front module mount plate 46. Each of the front and rear module mount plates 46, 48 include apertures 54 provided in protruding portions 50 that are configured to receive a bolt 56 for securing the battery modules 40 to the threaded apertures or nuts in the cross members 24, 28. FIG. 1 shows a perspective view of the nesting of the front module mount plates 46 and rear module mount plates 48 of the battery modules 40 with the remaining structure of the battery modules 40 removed for illustration purposes.

As shown in FIG. 1, the front module mount plates 46 and the rear module mount plates 48 are stacked on the lower cross bars 24 and the upper cross bars 28 which are secured to opposing sidewalls of the sidewall structure 16.

The front and rear module mount plates 46,48 can be cast or molded components that can be mounted to the housing of the battery modules 40. As shown in FIG. 7, the protruding portions 50 have a height that is less than a height of the battery module housing. A bottom surface of the protruding portions 50 is spaced above a bottom surface of the battery module housing by a distance that is approximately equal to a height of the cross members 24, 28.

The stackable battery modules mounting system enables direct module on module placement and larger modules. The mounting system includes cross bars with direct module mounting. The mounting is facilitated by the nested face castings 46,48 on the sides of the battery module housings 42. The stackable system does not require separate trays and requires fewer crossbars since a single crossbar supports two adjacent battery modules. The stackable system therefore provides a simplified assembly and significant part reduction. In addition, the battery modules fill the spaces between the crossbars and the bolts 56 tie the upper and lower crossbars 24, 28 together through the lower module face plate 46, 48. This creates a solid sandwich arrangement. Accordingly, the direct module stacking has eliminated the need for the upper tray, reducing the cost and mass.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A stackable battery module mounting system, comprising:
a side wall structure;
a plurality of cross members extending between opposite sides of the side wall structure, the plurality of cross members each having a plurality of first spaced apertures;
a plurality of battery modules each having a face plate on opposite sides thereof and each face plate having a plurality of protruding sections which nest with protruding sections of the face casting of adjacent battery modules, at least some of the protruding sections including a second apertures aligned with a respective one of the first spaced apertures of the plurality of cross members; and
a plurality of bolts each received in corresponding ones of the second apertures and the first spaced apertures for securing the plurality of battery modules to the plurality of cross members.

2. The stackable battery module mounting system according to claim 1, wherein the plurality of battery modules include battery modules that are stacked upon another battery module.

3. The stackable battery module mounting system according to claim 1, wherein the plurality of cross members are connected to the side wall structure by a bracket secured to the side wall structure.

4. The stackable battery module mounting system according to claim 1, further comprising a base panel connected to the sidewall structure.

5. The stackable battery module mounting system according to claim 4, wherein the plurality of cross members include a plurality of lower cross members that are connected to the base panel and a plurality of upper cross members that are connected to the sidewall structure by mounting brackets.

6. The stackable battery module mounting system according to claim 5, wherein the plurality of battery modules include a first plurality of battery modules connected to the plurality of lower cross members and a second plurality of battery modules stacked on top of the plurality of first battery modules and connected to the plurality of upper cross members.

7. The stackable battery module mounting system according to claim 1, wherein the plurality of protruding sections of the face plates of the battery modules are spaced upward from a bottom of the plurality of battery modules by a distance approximately equal to a vertical height of the cross members.

8. The stackable battery module mounting system according to claim 1, wherein the plurality of protruding sections include between 2 and 10 protruding sections.

9. The stackable battery module mounting system according to claim 8, wherein the face plates of the plurality of battery modules includes a plurality of recesses between the plurality of protruding sections.

10. A stackable battery module mounting system, comprising:
a base panel;
a side wall structure connected to the base panel;
a plurality of lower cross members connected to the base panel and extending between opposite sides of the side wall structure, the plurality of lower cross members each having a plurality of first spaced apertures;
a plurality of upper cross members connected to the side wall structure above respective ones of the plurality of lower cross members, the plurality of upper cross members each having a plurality of second spaced apertures;
a plurality of first battery modules each having a face plate on opposite sides thereof and each face plate having a plurality of protruding sections which nest with protruding sections of a face plate of adjacent battery modules, at least some of the protruding sections including a third aperture aligned with a respective one of the first spaced apertures of the plurality of lower cross members;
a plurality of second battery modules stacked on top of respective ones of the plurality of first battery modules and each having a face plate on opposite sides thereof and each face plate having a plurality of protruding sections which nest with protruding sections of a face plate of adjacent battery modules, at least some of the protruding sections including a fourth aperture aligned with a respective one of the second spaced apertures of the plurality of upper cross members; and
a plurality of bolts each received in corresponding ones of the second apertures and the first spaced apertures for securing the plurality of battery modules to the plurality of cross members.

11. The stackable battery module mounting system according to claim 10, wherein the plurality of upper cross members are connected to the side wall structure by a bracket secured to the side wall structure.

12. The stackable battery module mounting system according to claim 10, wherein the plurality of protruding sections of the face plates of the battery modules are spaced upward from a bottom of the plurality of battery modules by a distance approximately equal to a vertical height of the cross members.

13. The stackable battery module mounting system according to claim 10, wherein the plurality of protruding sections include between 2 and 10 protruding sections.

14. The stackable battery module mounting system according to claim 14, wherein the face plates of the plurality of battery modules include a plurality of recesses between the plurality of protruding sections.

15. A stackable battery module mounting system, comprising:
a side wall structure;
a plurality of cross members extending between opposite sides of the side wall structure, the plurality of cross members each having a plurality of first spaced apertures;
a plurality of battery modules each having a face plate on opposite sides thereof and each face plate having a plurality of protruding sections which nest with protruding sections of face plates of adjacent battery modules, at least some of the protruding sections including a second aperture aligned with a respective one of the first spaced apertures of the plurality of cross members; and
a plurality of bolts each received in corresponding ones of the second apertures and the first spaced apertures for securing the plurality of battery modules to the plurality of cross members.

16. The stackable battery module mounting system according to claim 15, wherein the plurality of battery modules include battery modules that are stacked upon another battery module.

17. The stackable battery module mounting system according to claim 15, wherein the plurality of cross members are connected to the side wall structure by a bracket secured to the side wall structure.

18. The stackable battery module mounting system according to claim 15, further comprising a base panel connected to the sidewall structure.

19. The stackable battery module mounting system according to claim 4, wherein the plurality of cross members include a plurality of lower cross members that are connected to the base panel and a plurality of upper cross members that are connected to the sidewall structure by mounting brackets.

20. The stackable battery module mounting system according to claim 5, wherein the plurality of battery modules include a first plurality of battery modules connected to the plurality of lower cross members and a second plurality of battery modules stacked on top of the plurality of first battery modules and connected to the plurality of upper cross members.
